(19) United States
(12) Patent Application Publication
(10) Pub. No.: US 2026/0006082 A1
(43) Pub. Date: Jan. 1, 2026

(54) EXECUTION OF NETWORK COMMUNICATION TASKS VIA PROXY

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 19/236,236

(22) Filed: Jun. 12, 2025

Related U.S. Application Data
(60) Provisional application No. 63/664,575, filed on Jun. 26, 2024.

(51) Int. Cl. H04L 9/40

(52) U.S. Cl. CPC H04L 63/205; H04L 63/08

(57) ABSTRACT

Novel tools and techniques are provided for implementing execution of network communication tasks via proxy. In various examples, an interpreter, operating on a first network device, may receive an instruction package, including a set of instructions for the interpreter to handle a network communication task, a time-to-live (“TTL”) value for handling the network communication task, and authentication information for communicating with a network system(s) to perform the network communication task. The interpreter may initiate a task attempt to execute the network communication task, based on the instruction package. Based on an indication that the task attempt has failed, the interpreter may initiate a plurality of repeated task attempts, based on the set of instructions and the TTL value. In response to a trigger event, the first interpreter may stop subsequent task attempts, and may generate and store a receipt associated with a latest task attempt in a data store.

### CROSS-REFERENCE TO RELATED APPLICATIONS

This application claims the benefit of U.S. Provisional Application No. 63/664,575 filed Jun. 26, 2024, entitled “Execution of Network Communication Tasks Via Proxy,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network communication, and, more particularly, to methods, systems, and apparatuses for implementing execution of network communication tasks via proxy.

### BACKGROUND

Frequently, servers may become unreachable or may be overloaded. This may be due to a number of reasons, including power or circuit failure, hardware misconfiguration, timeout errors, etc. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing execution of network communication tasks via proxy, in accordance with various embodiments.

FIG. 2 depicts another example system for implementing execution of network communication tasks via proxy, in accordance with various embodiments.

FIG. 3 depicts a flow diagram illustrating an example method for implementing execution of network communication tasks via proxy, in accordance with various embodiments.

FIG. 4 depicts a flow diagram illustrating another example method for implementing execution of network communication tasks via proxy, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a first interpreter, which may be operating on a first network device, may receive a first instruction package associated with the first interpreter. The first instruction package may include a first set of instructions for the first interpreter to handle a network communication task, a first time-to-live (“TTL”) value for handling the network communication task, and authentication information for communicating with one or more network systems to perform the network communication task. The first interpreter may initiate a first attempt to execute the network communication task, based on the first instruction package. Based on an indication that the first attempt has failed, the first interpreter may initiate a plurality of repeated attempts to execute the network communication task, in accordance with the first set of instructions and the first TTL value in the first instruction package. In response to a first trigger event, the first interpreter may stop subsequent attempts to execute the network communication task, and may generate and store a first receipt associated with a latest attempt to execute the network communication task in a data store.

In another aspect, in response to encountering an error in executing a network communication task, a computing system, or a function that is executed on the computing system, may cause an instruction package to be created. The instruction package may include a set of instructions for an interpreter to handle the network communication task, a TTL value for handling the network communication task, and authentication information for communicating with one or more network systems to perform the network communication task. The computing system may transfer responsibility for continuing attempts to execute the network communication task to the interpreter, where the interpreter initiates or resumes attempts to execute the network communication task based on the instruction package.

These and other aspects of the execution of network communication tasks via proxy are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a first interpreter operating on a first network device, a first instruction package associated with the first interpreter. The first instruction package may include a first set of instructions for the first interpreter to handle a network communication task, a first time-to-live (“TTL”) value for handling the network communication task, and authentication information for communicating with one or more network systems to perform the network communication task. The method may further include initiating, by the first interpreter, a first attempt to execute the network communication task, based on the first instruction package. The method may further include, based on an indication that the first attempt has failed, initiating, by the first interpreter, a plurality of repeated attempts to execute the network communication task, in accordance with the first set of instructions and the first TTL value in the first instruction package. The method may further include, in response to a first trigger event, stopping, by the first interpreter, subsequent attempts to execute the network communication task, and generating and storing, by the first interpreter, a first receipt associated with a latest attempt to execute the network communication task in a data store.

In another aspect, the technology relates to an interpreter, which is operating on a first network device. The interpreter may be configured to receive a first instruction package associated with the interpreter. The first instruction package may include a first set of instructions for the interpreter to handle a network communication task, a first TTL value for handling the network communication task, and authentication information for communicating with one or more network systems to perform the network communication task. The interpreter may be further configured to initiate a first attempt to execute the network communication task, based on the first instruction package. The interpreter may be further configured to, based on an indication that the first attempt has failed, initiate a plurality of repeated attempts to execute the network communication task, in accordance with the first set of instructions and the first TTL value in the first instruction package. The interpreter may be further configured to, in response to a first trigger event, stop subsequent attempts to execute the network communication task, and generate and store a first receipt associated with a latest attempt to execute the network communication task in a data store.

In yet another aspect, the technology relates to a method, including, in response to encountering an error in executing a network communication task, causing, by a computing system or by a function that is executed on the computing system, an instruction package to be created. The instruction package may include a set of instructions for an interpreter to handle the network communication task, a TTL value for handling the network communication task, and authentication information for communicating with one or more network systems to perform the network communication task. The method may further include transferring, by the computing system, responsibility for continuing attempts to execute the network communication task to the interpreter, wherein the interpreter initiates or resumes attempts to execute the network communication task based on the instruction package.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### SPECIFIC EXEMPLARY EMBODIMENTS

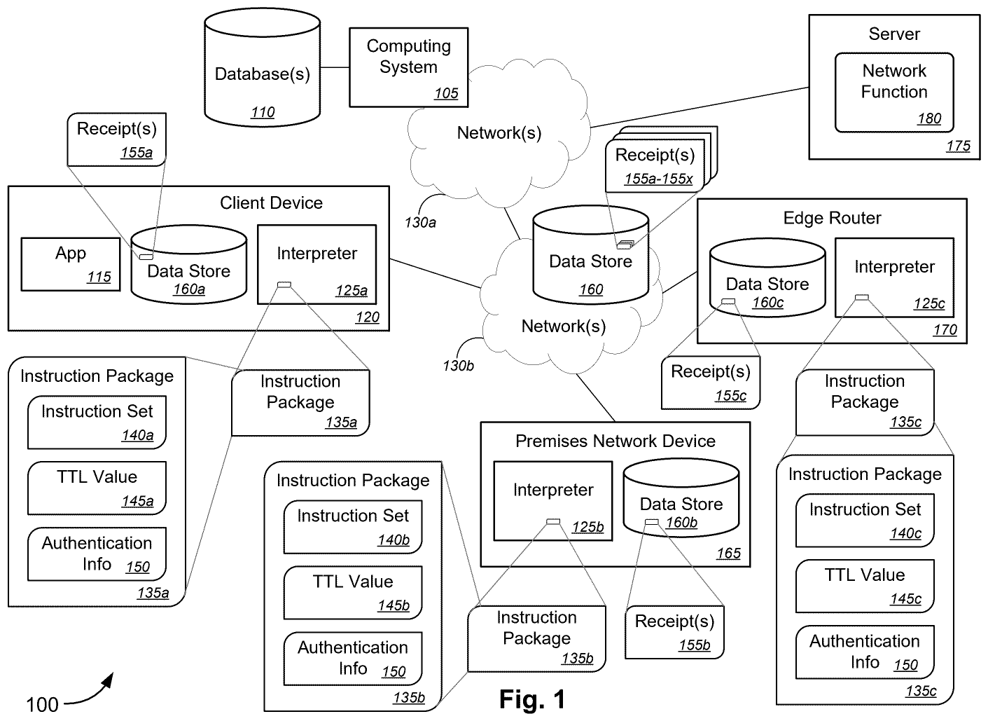

Turning to the embodiments as illustrated by the drawings, FIGS. 1-5 illustrate some of the features of methods, systems, and apparatuses for implementing network communication, and, more particularly, to methods, systems, and apparatuses for implementing execution of network communication tasks via proxy, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing execution of network communication tasks via proxy, in accordance with various embodiments. As shown in FIG. 1, system 100 may include a computing system 105 and a corresponding database(s) 110. System 100 may further include a software application (“app”) 115 that may be hosted on client device 120. In examples, system 100 may further include a first interpreter 125a that may be operating on the client device 120. The first interpreter 125a may be configured to initiate and/or perform attempts to execute a network communication task(s), based on the first instruction package 135a, after the app 115 has failed to execute the network communication task(s) and has handed off the network communication task(s) to the first interpreter 125a. In an example, the computing system 105 may cause the first interpreter 125a and/or the first instruction package 135a to be created on client device 120 via network(s) 130a and 130b or may send one or both components to client device 120 via network(s) 130a and 130b. In another example, the client device 120 may create the first interpreter 125a and/or may create the first instruction package 135a. In some examples, the first instruction package 135a may include a first set of instructions 140a for the first interpreter 125a to handle the network communication task(s), a first time-to-live (“TTL”) value 145a for handling the network communication task(s), and authentication information 150 for communicating with one or more network systems to perform the network communication task(s) (e.g., communicating with server 175 and/or a network function 180 operating on the server 175, or the like). In the case that the first interpreter 125a fails at its attempts to execute the network communication task(s), in some instances, as indicated by a first trigger event, the first interpreter 125a may generate a first receipt(s) 155a that is associated with its latest attempt to execute the network communication task(s) and may store the first receipt(s) 155a in either data store 160a that may be disposed on client device 120 and/or data store 160 that is disposed in network(s) 130b.

System 100 may further include premises network device 165, edge router 170, and server 175 each of which may be communicatively coupled with client device 120 and/or computing system 105 via network(s) 130a and/or 130b. In examples, premises network device 165 may include a second interpreter 125b and data store 160b. In some instances, the second interpreter 125b and/or a second instruction package 135b may be created, sent, and/or received by computing system 105, client device 120, or premises network device 165, in a manner similar to how the first interpreter 125a may be created, sent, and/or received. The first interpreter 125a may be further configured to hand-off the network communication task(s) to the second interpreter 125b. The second interpreter 125b may be configured to initiate and/or perform attempts to execute network communication task(s), based on the second instruction package 135b, after the first interpreter 125a has handed off the network communication task(s) to the second interpreter 125b. In some examples, the second instruction package 135b may include a second set of instructions 140b for the second interpreter 125b to handle the network communication task(s), a second TTL value 145b for handling the network communication task(s), and authentication information 150 for communicating with the one or more network systems to perform the network communication task(s). In the case that the second interpreter 125b fails at its attempts to execute the network communication task(s), in some instances, as indicated by a trigger event (similar to the first trigger event), the second interpreter 125b may generate a second receipt(s) 155b that is associated with its latest attempt to execute the network communication task(s) and may store the second receipt(s) 155b in either data store 160b that may be disposed on premises network device 165 and/or data store 160 that is disposed in network(s) 130b.

In examples, edge router 170 may include a third interpreter 125c and data store 160c. In some instances, the third interpreter 125c and/or a third instruction package 135c may be created, sent, and/or received by computing system 105, premises network device 165, or edge router 170, in a manner similar to how the first interpreter 125a and/or the second interpreter 125b may be created, sent, and/or received. In examples, an edge router (such as edge router 170, etc.) may be a network device that is located within an edge network between a core network and one or more access networks of a service provider, or that otherwise separates one autonomous network from another (whether located within a core network, an access network, an autonomous network, or other network). In some cases, a premises network device (e.g., premises network device 165, etc.) is a network device that is located at a premises, as described below. In some instances, a client device (e.g., client device 120, etc.) is a network device that may include a mobile network device (e.g., a mobile user device, etc.) or other user device (e.g., a desktop computer or other less mobile user device, etc.) that may at least occasionally come within communication range with a premises network device (e.g., premises network device 165, etc.). The second interpreter 125b may be further configured to hand-off the network communication task(s) to the third interpreter 125c. The third interpreter 125c may be configured to initiate and/or perform attempts to execute network communication task(s), based on the third instruction package 135c, after the second interpreter 125b has handed off the network communication task(s) to the third interpreter 125c. In some examples, the third instruction package 135c may include a third set of instructions 140c for the third interpreter 125c to handle the network communication task(s), a third TTL value 145c for handling the network communication task(s), and authentication information 150 for communicating with the one or more network systems to perform the network communication task(s). In the case that the third interpreter 125c fails at its attempts to execute the network communication task(s), in some instances, as indicated by a trigger event (similar to the first trigger event), the third interpreter 125c may generate a third receipt(s) 155c that is associated with its latest attempt to execute the network communication task(s) and may store the third receipt(s) 155c in either data store 160c that may be disposed on edge router 170 and/or data store 160 that is disposed in network(s) 130b. Data store 160 may be used to store receipt(s) 155a-155x, which may include receipts 155a, 155b, and 155c. Additional layers of interpreters 125 on other network elements are possible and contemplated.

In examples, the network communication task includes one of establishing a network connection with another device, sending data over a network connection, receiving data over the network connection, sending a message over a network connection to a messaging system, receiving a message over a network connection from the messaging system, sending an email over a network connection to a webmail system, receiving an email over a network connection from the webmail system, storing local data in a network storage system, or retrieving data from the network storage system, and/or the like. In some instances, the first set of instructions 140a for the interpreter to handle the network communication task includes instructions for reattempting execution of the network communication task, instructions for handoff to another interpreter (e.g., interpreter 125b or 125c, or the like) or to another system (e.g., premises network device 165 or edge router 170, or the like) based on a set of criteria, instructions for negotiating TTL values with the other interpreter or with the other system. In some cases, the second set of instructions 140b for the interpreter to handle the network communication task includes instructions for reattempting execution of the network communication task, instructions for handoff to yet another interpreter (e.g., interpreter 125c, or the like) or to yet another system (e.g., edge router 170, or the like) based on a set of criteria, instructions for negotiating TTL values with the yet another interpreter or with the other system. In some examples, the third set of instructions 140c for the interpreter to handle the network communication task includes instructions for reattempting execution of the network communication task, instructions for handoff to still another interpreter or to still another system based on a set of criteria, instructions for negotiating TTL values with the still another interpreter or with the other system.

In examples, an indication that an attempt by any of the interpreters 125a-125c has failed may include one of an error message, a message indicating no network connection, a message indicating a network connection loss, a message indicating a domain name system (“DNS”) failure, a message indicating inability to complete the network communication task(s), or a message indicating that the attempt has timed out, and/or the like. In some examples, the first or other similar trigger event may include exceeding the corresponding TTL value, the corresponding interpreter 125a, 125b, or 125c receiving instructions to stop subsequent attempts to execute the network communication task(s), or the corresponding interpreter 125a, 125b, or 125c receiving an indication that the latest attempt to execute the network communication task(s) has succeeded, and/or the like.

In some examples, the computing system 105 may include at least one of a software application, a web browser, a network communication system, an operating system (“OS”), an orchestrator, a processor, or a server, and/or the like. In some instances, the client device 120 may include, but is not limited to, one of a desktop computer, a laptop computer, a tablet computer, a smart phone, a mobile phone, or a network device, and/or the like. In some cases, the network device (or the premises network device 165) may include one of customer premises equipment (“CPE”), a modem, a gateway device, or a network access point, and/or the like. In examples, the premises, on which the premises network device 165 may be located, may include one of a residential premises, a business premises, a corporate premises, an enterprise premises, an education facility premises, a medical facility premises, or a governmental premises, and/or the like. In some instances, network function 245 may include one of a message function, an webmail function, and/or a DNS service function, and/or the like.

According to some embodiments, networks 130a and 130b may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 130a and 130b may include an access network of the service provider (e.g., an Internet service provider (“ISP”)). In another embodiment, the networks 130a and 130b may include a core network of the service provider and/or the Internet.

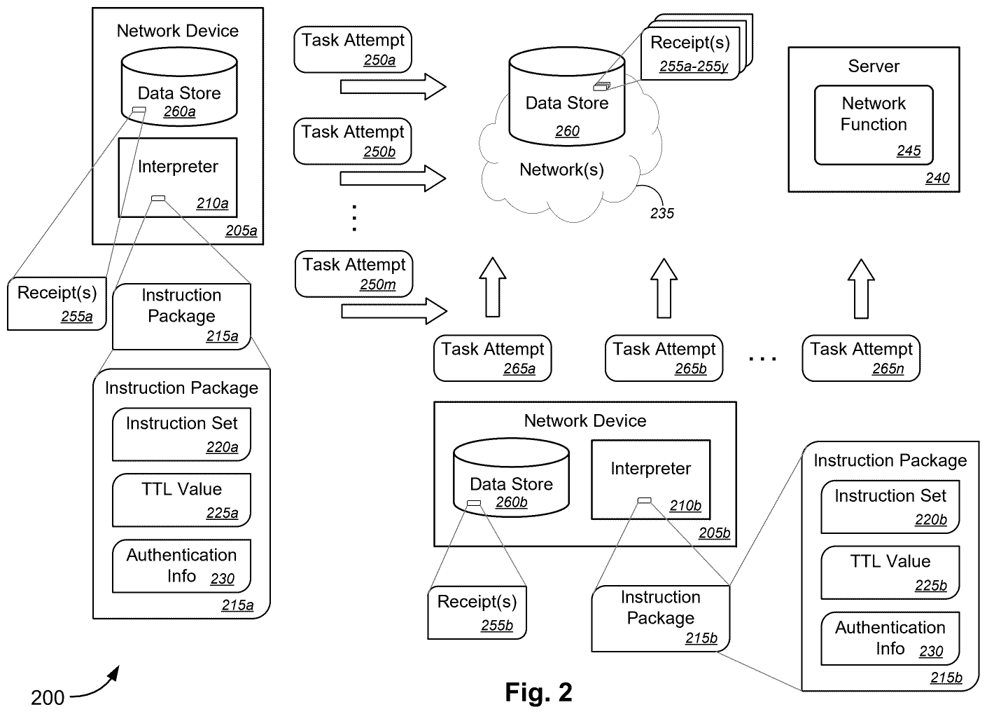

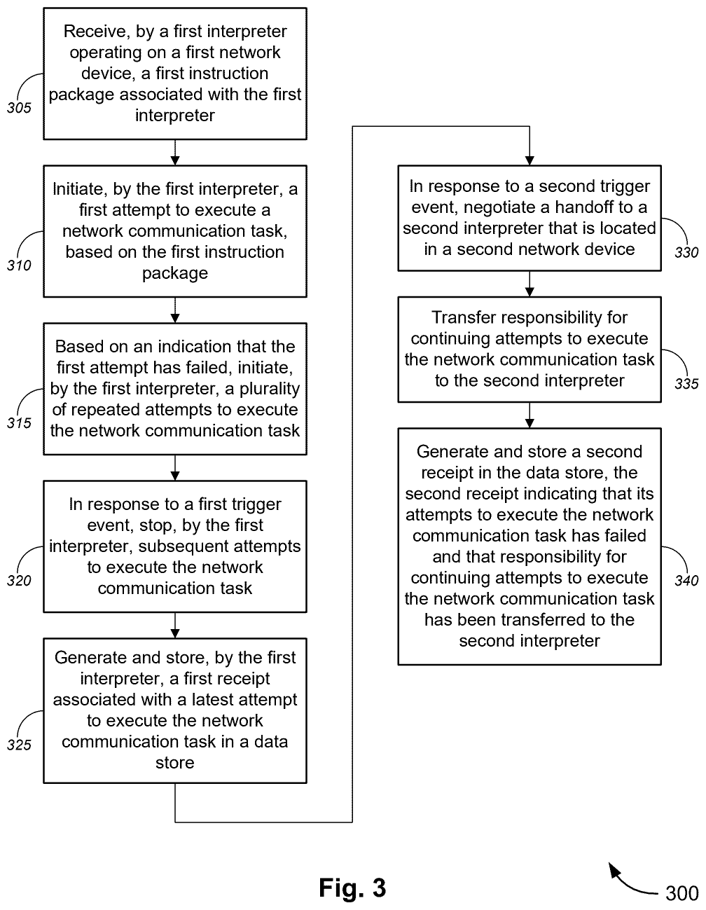

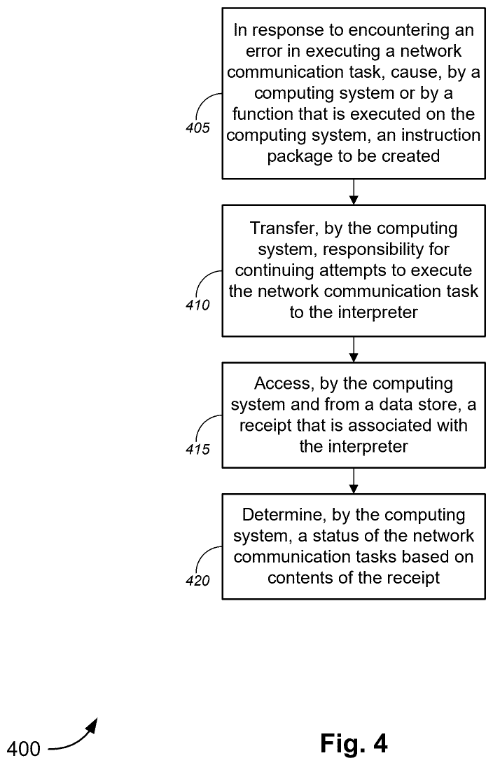

In operation, computing system 105 and/or interpreter 125a, 125b, and/or 125c (collectively, “interpreters 125” or the like) may perform methods for implementing execution of network communication tasks via proxy (i.e., based on instruction packages 135a, 135b, and/or 135c (collectively, “instruction packages 135” or the like), respectively), as described in detail with respect to FIGS. 2-4. For example, operations as described below with respect to system 200 of FIG. 2, and methods 300 and 400 as described below with respect to FIGS. 3 and 4, respectively, may be applied with respect to the operations of system 100 of FIG. 1.

FIG. 2 depicts another example system 200 for implementing execution of network communication tasks via proxy, in accordance with various embodiments.

In some embodiments, network device 205a, network device 205b, interpreters 210a, interpreters 210b, instruction packages 215a and 215b, instruction sets 220a and 220b, TTL values 225a and 225b, authentication information 230, network(s) 235, server 240, network function 245, receipt(s) 255a, receipt(s) 255b, receipt(s) 255a-255y, data store 260a, data store 260b, and data store 260 of FIG. 2 may be similar, if not identical, to the client device 120 or premises network device 165, premises network device 165 or edge router 170, interpreters 125a or 125b, interpreters 125b or 125c, instruction packages 135a-135c, instruction sets 140a-140c, TTL values 145a-145c, authentication information 150, network(s) 130a or 130b, server 175, network function 180, receipt(s) 155a or 155b, receipt(s) 155b or 155c, receipt(s) 155a-155x, data store 160a or 160b, data store 160b or 160c, and data store 160, respectively, of system 100 of FIG. 1, and the description of these components of system 100 of FIG. 1 are similarly applicable to the corresponding components of system 200 of FIG. 2. Herein, x and y are non-negative integer numbers that may be either all the same as each other, all different from each other, or some combination of same and different (e.g., one set of two or more having the same values with the others having different values, a plurality of sets of two or more having the same value with the others having different values, etc.).

With reference to FIG. 2, first interpreter 210a, which may be operating on a first network device 205a, may receive a first instruction package 215a associated with the first interpreter 210a. The first instruction package 215a may include a first set of instructions 220a for the first interpreter 210a to handle a network communication task(s), a first TTL value 225a for handling the network communication task(s), and authentication information 230 for communicating with one or more network systems (e.g., server 240) to perform the network communication task(s). The first interpreter 210a may initiate a first task attempt 250a to execute the network communication task(s), based on the first instruction package 215a. Based on an indication that the first task attempt 250a has failed, the first interpreter 210a may initiate a plurality of repeated task attempts 250b-250m to execute the network communication task(s), in accordance with the first set of instructions 220a and the first TTL value 225a in the first instruction package 215a. In response to a first trigger event, the first interpreter 210a may stop subsequent task attempts to execute the network communication task(s), and may generate and store a first receipt (e.g., receipt(s) 255a) associated with a latest task attempt (e.g., task attempt 250m, or the like) to execute the network communication task(s) in a data store (e.g., data store 260a that is disposed in the first network device 205a or data store 260 that is disposed in network(s) 235, or the like). In some examples, the first trigger event may include exceeding the first TTL value 225a, the first interpreter 210a receiving instructions to stop subsequent task attempts 250 to execute the network communication task(s), or the first interpreter 210a receiving an indication that the latest task attempt to execute the network communication task(s) has succeeded.

In response to a second trigger event, the first interpreter 210a may negotiate a handoff to one of a second interpreter 210b that is located in second network device 205b. In some cases, negotiating the handoff may include negotiating a transfer of responsibility to continue attempting to execute the network communication task(s) from the first interpreter 210a to the second interpreter 210b, and negotiating a second TTL value 225b for the second interpreter 210b to handle the network communication task(s). The first interpreter 210a may transfer responsibility for continuing attempts to execute the network communication task(s) to the second interpreter 210b. The second interpreter 210b may resume attempts to execute the network communication task(s) (e.g., task attempts 265a-265n, or the like) based on a second instruction package 215b. The second instruction package 215b may include a second set of instructions 220b for the second interpreter 210b to handle the network communication task(s), the second TTL value 225b for handling the network communication task(s), and the authentication information 230 for communicating with the one or more network systems to perform the network communication task(s). The first interpreter 210a may generate and store a second receipt (e.g., receipt(s) 255a) in the data store (e.g., data store 260a or 260, or the like), the second receipt indicating that its attempts to execute the network communication task(s) have failed and that responsibility for continuing attempts to execute the network communication task(s) has been transferred to the second interpreter 210b.

In some cases, the first receipt and the second receipt may be the same receipt that is updated with current information, such as to which interpreter responsibility for continuing the attempts to execute the network communication task(s) has been transferred, attempt successes, and/or attempt failures, and/or the like. A receipt(s) 255b, which may be similar to the first receipt and/or the second receipt, may be stored in data store 260 and/or 260b that is disposed in the second network device 205b, the receipt(s) 225b being associated with a latest task attempt (e.g., task attempt 265n, or the like) to execute the network communication task(s) and/or indicating that task attempts 265a-265n to execute the network communication task(s) have failed and that responsibility for continuing attempts to execute the network communication task(s) has been transferred to another interpreter 210b (or that task attempts have stopped without responsibility for continuing attempts being transferred). Herein, m and n are non-negative integer numbers that may be either all the same as each other, all different from each other, or some combination of same and different (e.g., one set of two or more having the same values with the others having different values, a plurality of sets of two or more having the same value with the others having different values, etc.). In some cases, the first receipt may include a third TTL value associated with it and the first receipt may be deleted after a first counter exceeds the third TTL value. In some instances, the second receipt may include a fourth TTL value associated with it and the second receipt may be deleted after a second counter exceeds the fourth TTL value. In some examples, data store 260 may be used to store receipt(s) 255a-255y, which may include receipts 255a and 255b.

In examples, the second trigger event may include one of the first interpreter 210a receiving a server-side error (e.g., an error at server 240, or the like), the first interpreter 210a receiving an indication that its resources or resources of the first network device 205a are no longer sufficient to continue attempting to execute the network communication task(s), or the first interpreter 210a determining that its resources or resources of the first network device 205a are no longer sufficient to continue attempting to execute the network communication task(s). In some examples, the second set of instructions 220b for the second interpreter 210b to handle the network communication task(s) includes instructions for reattempting execution of the network communication task(s) (e.g., for task attempts 265a-265n), instructions for handoff to yet another interpreter or to yet another system based on a set of criteria, and instructions for negotiating TTL values with the yet another interpreter or with the yet another system. In some cases, the second instruction package 215b may be a file upload of the first instruction package 215a that is modified with the second TTL value 225b. In examples, each of the first instruction package 215a and the second instruction package 215b may include data needed for executing the network communication task(s) and for handoff operations. In some instances, each of the first and second interpreters 210a and 210b may be self-contained systems that may execute instructions and may use data contained in the first instruction package 215a or the second instruction package 215b, respectively, without requiring instructions or data external to the corresponding instruction package 215a or 215b.

In some aspects, referring to FIGS. 1 and 2, the present technology provides a proxy (e.g., an interpreter 125 or 210, or the like) that is capable of collecting and reattempting delivery of payloads through a sealed virtual package (e.g., an instruction package 135 or 215, or the like). The sealed virtual package may collect a set of details (such as a script, or the like) including re-authentication and server details of valid or trusted final delivery, etc. An example may include a webmail server that may be unavailable and may be unable to accept an outbound message. This proxy (or interpreter 125 or 210) may intercept the communication details and may provide scheduled reattempts (e.g., task attempts 250a-250m and/or 265a-265n or the like) until either a time-to-live (e.g., TTL values 225a or 225b) expires or the payload has been delivered. The proxy (or interpreter 125 or 210) could be several layers deep. For example, a proxy (e.g., interpreter 125a or 210a of FIG. 1 or 2, or the like) on a client device (e.g., client device 120 of FIG. 1, or the like) may store and forward a payload if no network connection is available, and may offload the payload to another proxy (e.g., interpreter 125b or 210b of FIG. 1 or 2, or the like) on a home network (e.g., premises network device 165 of FIG. 1, or the like), if the server (e.g., server 175 or 240 of FIG. 1 or 2, or the like) is still unavailable, or the like. Delivery and error states may be probed at each level to manage final success or failures, or handoffs, or the like.

FIG. 3 depicts a flow diagram illustrating an example method 300 for implementing execution of network communication tasks via proxy, in accordance with various embodiments.

With reference to FIG. 3A, method 300 may include, at operation 305, receiving, by a first interpreter (e.g., interpreter 125a, 125b, or 210a of FIG. 1 or 2, or the like) operating on a first network device (e.g., client device 120, premises network device 165, or network device 205a of FIG. 1 or 2, or the like), a first instruction package (e.g., instruction package 135a, 135b, or 215a of FIG. 1 or 2, or the like) associated with the first interpreter. The first instruction package may include a first set of instructions (e.g., instruction set 140a, 140b, or 220a of FIG. 1 or 2, or the like) for the first interpreter to handle the network communication task, a first TTL value (e.g., TTL value 145a, 145b, or 225a of FIG. 1 or 2, or the like) for handling the network communication task, and authentication information (e.g., authentication information 150 or 230 of FIG. 1 or 2, or the like) for communicating with one or more network systems to perform a network communication task. At operation 310, method 300 may include initiating, by the first interpreter, a first attempt (e.g., task attempt 250a of FIG. 2, or the like) to execute the network communication task, based on the first instruction package.

In examples, the network communication task includes one of establishing a network connection with another device, sending data over a network connection, receiving data over the network connection, sending a message over a network connection to a messaging system, receiving a message over a network connection from the messaging system, sending an email over a network connection to a webmail system, receiving an email over a network connection from the webmail system, storing local data in a network storage system, or retrieving data from the network storage system, and/or the like. In some cases, the first set of instructions for the interpreter to handle the network communication task includes instructions for reattempting execution of the network communication task, instructions for handoff to another interpreter or to another system based on a set of criteria, and instructions for negotiating TTL values with the other interpreter or with the other system, and/or the like.

Method 300 may further include, at operation 315, based on an indication that the first attempt has failed, initiating, by the first interpreter, a plurality of repeated attempts (e.g., task attempts 250a-250b of FIG. 2, or the like) to execute the network communication task, in accordance with the first set of instructions and the first TTL value in the first instruction package. In examples, the indication that the first attempt has failed includes at least one of an error message, a message indicating no network connection, a message indicating a network connection loss, a message indicating a DNS failure, a message indicating inability to complete the network communication task, or a message indicating that the first attempt has timed out. Method 300 may further include, in response to a first trigger event, stopping, by the first interpreter, subsequent attempts to execute the network communication task (operation 320), and generating and storing, by the first interpreter, a first receipt (e.g., receipt(s) 155a, 155b, or 255a of FIG. 1 or 2, or the like) associated with a latest attempt to execute the network communication task in a data store (e.g., data store 160, 160a, 160b, 260, or 260a of FIG. 1 or 2, or the like) (at operation 325).

In the case that the first interpreter is located in a first network device, at operation 330, method 300 may further include, in response to a second trigger event, negotiating, by the first interpreter, a handoff to a second interpreter (e.g., interpreter 125b, 125c, or 210b of FIG. 1 or 2, or the like) that is located in a second network device (or to another system) (e.g., premises network device 165, edge router 170, network device 205b of FIG. 1 or 2, or the like). In examples, the first (or second) trigger event includes exceeding the first (or second) TTL value, the first (or second) interpreter receiving instructions to stop subsequent attempts to execute the network communication task, the first (or second) interpreter receiving an indication that the latest attempt to execute the network communication task has succeeded. In some examples, negotiating the handoff may include negotiating a transfer of responsibility to continue attempting to execute the network communication task from the first interpreter to the second interpreter (or to the other system), and negotiating a second TTL value (e.g., TTL value 145b, 145c, or 225b of FIG. 1 or 2, or the like) for the second interpreter (or the other system) to handle the network communication task.

Method 300 may further include, at operation 335, the first interpreter transferring responsibility for continuing attempts to execute the network communication task to the second interpreter (or to the other system). In some examples, the second interpreter (or the other system) may resume attempts to execute the network communication task based on a second instruction package (e.g., instruction package 135b, 135c, or 215b of FIG. 1 or 2, or the like). The second instruction package may include a second set of instructions (e.g., instruction set 140b, 140c, or 220b of FIG. 1 or 2, or the like) for the second interpreter (or the other system) to handle the network communication task, the second TTL value for handling the network communication task, and the authentication information for communicating with the one or more network systems to perform the network communication task.

Method 300 may further include generating and storing, by the first interpreter, a second receipt (e.g., receipt(s) 155b, 155c, or 255b of FIG. 1 or 2, or the like) in the data store (e.g., data store 160, 160b, 160c, 260, or 260b of FIG. 1 or 2, or the like) (at operation 340). The second receipt may indicate that its attempts to execute the network communication task have failed and that responsibility for continuing attempts to execute the network communication task has been transferred to the second interpreter (or to the other system).

In examples, the second trigger event includes one of the first interpreter receiving a server-side error, the interpreter receiving an indication that its resources or resources of the first network device are no longer sufficient to continue attempting to execute the network communication task, or the interpreter determining that its resources or resources of the first network device are no longer sufficient to continue attempting to execute the network communication task, and/or the like. In some instances, the second set of instructions for the one of the second interpreter or the other system to handle the network communication task includes instructions for reattempting execution of the network communication task, instructions for handoff to yet another interpreter or to yet another system based on a set of criteria, and instructions for negotiating TTL values with the yet another interpreter or with the yet another system. In some cases, the second instruction package is a file upload of the first instruction package that is modified with the second TTL value. In some examples, each of the first instruction package and the second instruction package includes data needed for executing the network communication task and for handoff operations. In some instances, each of the first and second interpreters are self-contained systems that execute instructions and use data contained in the first instruction package or the second instruction package, respectively, without requiring instructions or data external to the corresponding instruction package. In examples, the first receipt has a third TTL value associated with it and the first receipt is deleted after a first counter exceeds the third TTL value. In some cases, the second receipt has a fourth TTL value associated with it and the second receipt is deleted after a second counter exceeds the fourth TTL value.

FIG. 4 depicts a flow diagram illustrating another example method 400 for implementing execution of network communication tasks via proxy, in accordance with various embodiments.

With reference to FIG. 4, method 400, at operation 405, may include, in response to encountering an error in executing a network communication task, causing, by a computing system or by a function that is executed on the computing system, an instruction package to be created. The instruction package may include a set of instructions for an interpreter to handle the network communication task, a TTL value for handling the network communication task, and authentication information for communicating with one or more network systems to perform the network communication task. At operation 410, method 400 may include transferring, by the computing system, responsibility for continuing attempts to execute the network communication task to the interpreter. In examples, the interpreter may initiate or may resume attempts to execute the network communication task based on the instruction package.

In some examples, the computing system includes one of a software application, a web browser, a network communication system, an OS, an orchestrator, a processor, or a server, and/or the like. In examples, the network communication task includes one of establishing a network connection with another device, sending data over a network connection, receiving data over the network connection, sending a message over a network connection to a messaging system, receiving a message over a network connection from the messaging system, sending an email over a network connection to a webmail system, receiving an email over a network connection from the webmail system, storing local data in a network storage system, or retrieving data from the network storage system, and/or the like. In some instances, the set of instructions for the interpreter to handle the network communication task includes instructions for reattempting execution of the network communication task, instructions for handoff to another interpreter or to another system based on a set of criteria, and instructions for negotiating TTL values with the other interpreter or with the other system, and/or the like.

Method 400 may further include, at operation 415, accessing, by the computing system and from a data store, a receipt that is associated with the interpreter. Method 400 may further include determining, by the computing system, a status of the network communication tasks based on contents of the receipt (at operation 420).

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

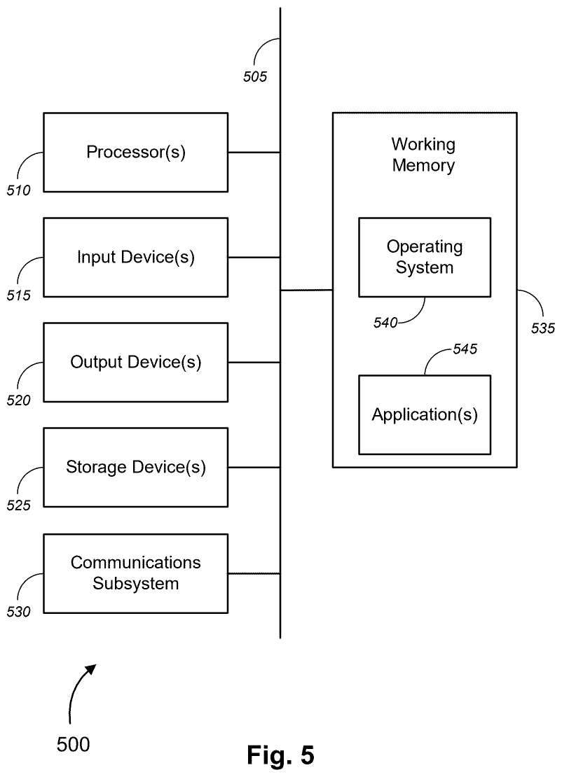

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 105, client device 120, interpreters 125a-125c and 210a-210b, premises network device 165, edge router 170, servers 175 and 240, and network devices 205a and 205b, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 105, client device 120, interpreters 125a-125c and 210a-210b, premises network device 165, edge router 170, servers 175 and 240, and network devices 205a and 205b, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a first interpreter operating on a first network device, a first instruction package associated with the first interpreter, the first instruction package including a first set of instructions for the first interpreter to handle a network communication task, a first time-to-live (“TTL”) value for handling the network communication task, and authentication information for communicating with one or more network systems to perform the network communication task;
initiating, by the first interpreter, a first attempt to execute the network communication task, based on the first instruction package;
based on an indication that the first attempt has failed, initiating, by the first interpreter, a plurality of repeated attempts to execute the network communication task, in accordance with the first set of instructions and the first TTL value in the first 12 instruction package; and
in response to a first trigger event, stopping, by the first interpreter, subsequent attempts to execute the network communication task, and generating and storing, by the first interpreter, a first receipt associated with a latest attempt to execute the network communication task in a data store.

2. The method of claim 1, wherein the indication that the first attempt has failed includes at least one of an error message, a message indicating no network connection, a message indicating a network connection loss, a message indicating a domain name system (“DNS”) failure, a message indicating inability to complete the network communication task, or a message indicating that the first attempt has timed out.

3. The method of claim 1, wherein the first trigger event includes exceeding the first TTL value, the first interpreter receiving instructions to stop subsequent attempts to execute the network communication task, or the first interpreter receiving an indication that the latest attempt to execute the network communication task has succeeded.

4. The method of claim 1, wherein the network communication task comprises one of establishing a network connection with another device, sending data over a network connection, receiving data over the network connection, sending a message over a network connection to a messaging system, receiving a message over a network connection from the messaging system, sending an email over a network connection to a webmail system, receiving an email over a network connection from the webmail system, storing local data in a network storage system, or retrieving data from the network storage system.

5. The method of claim 1, wherein the first set of instructions for the first interpreter to handle the network communication task includes instructions for reattempting execution of the 2 network communication task, instructions for handoff to another interpreter or to another system based on a set of criteria, and instructions for negotiating TTL values with the other interpreter or with the other system.

6. The method of claim 1, wherein the first interpreter is located in a first network device, wherein the method further comprises:
in response to a second trigger event, negotiating, by the first interpreter, a handoff to one of a second interpreter that is located in a second network device or another system, wherein negotiating the handoff includes negotiating a transfer of responsibility to continue attempting to execute the network communication task from the first interpreter to the one of the second interpreter or the other system, and negotiating a second TTL value for the one of the second interpreter or the other system to handle the network communication task;
transferring, by the first interpreter, responsibility for continuing attempts to execute the network communication task to the one of the second interpreter or the other system, wherein the one of the second interpreter or the other system resumes attempts to execute the network communication task based on a second instruction package, the second instruction package including a second set of instructions for the one of the second interpreter or the other system to handle the network communication task, the second TTL value for handling the network communication task, and the authentication information for communicating with the one or more network systems to perform the network communication task; and
generating and storing, by the first interpreter, a second receipt in the data store, the second receipt indicating that its attempts to execute the network communication task have failed and that responsibility for continuing attempts to execute the network communication task has been transferred to the one of the second interpreter or the other system.

7. The method of claim 6, wherein the second trigger event includes one of the first interpreter receiving a server-side error, the first interpreter receiving an indication that its resources or resources of the first network device are no longer sufficient to continue attempting to execute the network communication task, or the first interpreter determining that its resources or resources of the first network device are no longer sufficient to continue attempting to execute the network communication task.

8. The method of claim 6, wherein the second set of instructions for the one of the second interpreter or the other system to handle the network communication task includes instructions for reattempting execution of the network communication task, instructions for handoff to yet another interpreter or to yet another system based on a set of criteria, and instructions for negotiating TTL values with the yet another interpreter or with the yet another system, wherein the second instruction package is a file upload of the first instruction package that is modified with the second TTL value.

9. The method of claim 6, wherein each of the first instruction package and the second instruction package includes data needed for executing the network communication task and for handoff operations, wherein each of the first and second interpreters are self-contained systems that execute instructions and use data contained in the first instruction package or the second instruction package, respectively, without requiring instructions or data external to the corresponding instruction package.

10. The method of claim 6, wherein the first receipt has a third TTL value associated with it and the first receipt is deleted after a first counter exceeds the third TTL value, wherein the second receipt has a fourth TTL value associated with it and the second receipt is deleted after a second counter exceeds the fourth TTL value.

11. An interpreter, which is operating on a first network device, the interpreter being configured to:
receive a first instruction package associated with the interpreter, the first instruction package including a first set of instructions for the interpreter to handle a network communication task, a first time-to-live (“TTL”) value for handling the network communication task, and authentication information for communicating with one or more network systems to perform the network communication task;
initiate a first attempt to execute the network communication task, based on the first instruction package;
based on an indication that the first attempt has failed, initiate a plurality of repeated attempts to execute the network communication task, in accordance with the first set of instructions and the first TTL value in the first instruction package; and
in response to a first trigger event, stop subsequent attempts to execute the network communication task, and generate and store a first receipt associated with a latest attempt to execute the network communication task in a data store.

12. The interpreter of claim 11, wherein the indication that the first attempt has failed includes at least one of an error message, a message indicating no network connection, a message indicating a network connection loss, a message indicating a domain name system (“DNS”) failure, a message indicating inability to complete the network communication task, or a message indicating that the first attempt has timed out.

13. The interpreter of claim 11, wherein the trigger event includes exceeding the first TTL value, the first interpreter receiving instructions to stop subsequent attempts to execute the network communication task, or the first interpreter receiving an indication that the latest attempt to execute the network communication task has succeeded.

14. The interpreter of claim 11, wherein the interpreter is further configured to:
in response to a second trigger event, negotiate a handoff to a second interpreter that is located in a second network device, wherein negotiating the handoff includes negotiating a transfer of responsibility to continue attempting to execute the network communication task from the interpreter to the second interpreter, and negotiating a second TTL value for the second interpreter to handle the network communication task;
transfer responsibility for continuing attempts to execute the network communication task to the second interpreter, wherein the second interpreter resumes attempts to execute the network communication task based on a second instruction package, the second instruction package including a second set of instructions for the second interpreter to handle the network communication task, the second TTL value for handling the network communication task, and the authentication information for communicating with the one or more network systems to perform the network communication task; and
generate and store a second receipt in the data store, the second receipt indicating that its attempts to execute the network communication task have failed and that responsibility for continuing attempts to execute the network communication task has been transferred to the second interpreter.

15. The interpreter of claim 14, wherein the second trigger event includes one of the first interpreter receiving a server-side error, the interpreter receiving an indication that its resources or resources of the first network device are no longer sufficient to continue attempting to execute the network communication task, or the interpreter determining that its resources or resources of the first network device are no longer sufficient to continue attempting to execute the network communication task.

16. A method, comprising:
in response to encountering an error in executing a network communication task, causing, by a computing system or by a function that is executed on the computing system, an instruction package to be created, the instruction package including a set of instructions for an interpreter to handle the network communication task, a time-to-live (“TTL”) value for handling the network communication task, and authentication information for communicating with one or more network systems to perform the network communication task;
transferring, by the computing system, responsibility for continuing attempts to execute the network communication task to the interpreter, wherein the interpreter initiates or resumes attempts to execute the network communication task based on the instruction package.

17. The method of claim 16, wherein the computing system comprises one of a software application, a web browser, a network communication system, an operating system (“OS”), an orchestrator, a processor, or a server.

18. The method of claim 16, wherein the network communication task comprises one of establishing a network connection with another device, sending data over a network connection, receiving data over the network connection, sending a message over a network connection to a messaging system, receiving a message over a network connection from the messaging system, sending an email over a network connection to a webmail system, receiving an email over a network connection from the webmail system, storing local data in a network storage system, or retrieving data from the network storage system.

19. The method of claim 16, wherein the set of instructions for the interpreter to handle the network communication task includes instructions for reattempting execution of the network communication task, instructions for handoff to another interpreter or to another system based on a set of criteria, and instructions for negotiating TTL values with the other interpreter or with the other system.

20. The method of claim 16, further comprising:
accessing, by the computing system and from a data store, a receipt that is associated with the interpreter; and
determining, by the computing system, a status of the network communication tasks based on contents of the receipt.
